(19) United States
(12) Patent Application Publication
(10) Pub. No.: US 2025/0093610 A1
(43) Pub. Date: Mar. 20, 2025

(54) PACKAGE FOR OPTICAL FIBER, PACKAGED ARTICLE, AND OPTICAL FIBER LEAD-OUT METHOD

(71) Applicant: SUMITOMO ELECTRIC OPTIFRONTIER CO., LTD., Yokohama-shi, Kanagawa (JP)

(72) Inventors: Junji FUKUI, Kanagawa (JP); Yoshikyo TAMEKUNI, Kanagawa (JP); Hisahiko NARUKAWA, Aichi (JP); Yuji MATSUMOTO, Aichi (JP); Tuan Nghia DUONG, Aichi (JP)

(73) Assignee: SUMITOMO ELECTRIC OPTIFRONTIER CO., LTD., Yokohama-shi, Kanagawa (JP)

(21) Appl. No.: 18/832,022

(22) PCT Filed: Jan. 18, 2023
(86) PCT No.: PCT/JP2023/001353

§ 371 Date: Jul. 22, 2024

(30) Foreign Application Priority Data
Jan. 21, 2022 (JP) 2022-008214

(51) Int. Cl. G02B 6/44

(52) U.S. Cl. CPC G02B 6/4457; G02B 6/44785

(57) ABSTRACT

A package for an optical fiber is a package configured to house an optical fiber having a connector mounted to at least one end of the optical fiber. The package includes: a base having a flat surface; a plurality of protrusions protruding from the flat surface of the base and arranged along an outer periphery of the base; a first mounting portion to which the connector of the optical fiber is mounted; and a plurality of falling-off prevention portions configured to regulate a position of the optical fiber, in which the plurality of protrusions are configured such that the optical fiber is wound along a part of an outer periphery of each of 10 the plurality of protrusions, and the first mounting portion includes a locking portion provided such that the first mounting portion is locked to an outer peripheral edge of the base or the optical fiber.

### TECHNICAL FIELD

The present disclosure relates to a package for an optical fiber, a package product, and an optical fiber lead-out method.

The present application claims priority based on Japanese Application No. 2022-008214 filed on Jan. 21, 2022, and incorporates all the contents described in the Japanese Application.

### BACKGROUND ART

Patent Literatures 1 and 2 disclose a housing case that houses an optical fiber provided with connectors at both ends. The housing case disclosed in Patent Literature 1 includes a main body and a bobbin around which the optical fiber is wound. The bobbin is rotatably housed in the main body. The optical fiber wound around the bobbin is housed in a space surrounded by an inner peripheral wall of the main body, an upper flange and a lower flange of the bobbin. Each of the connectors is fixed to a predetermined position of the housing case.

The housing case disclosed in Patent Literature 2 includes a main body, a bobbin around which the optical fiber is wound, and an upper cover that covers the main body, the bobbin, and the optical fiber. The bobbin is rotatably housed in the main body. The optical fiber wound around the bobbin is housed in a space surrounded by an inner peripheral wall of the main body, the bobbin, and the upper lid. Patent Literature 2 further discloses that a plurality of housing cases are stacked. In the housing case of Patent Literature 2, each connector is also fixed to a predetermined position.

### CITATION LIST

### Patent Literature

Patent Literature 1: JP2015-025906A

Patent Literature 2: JP2014-105021A

### SUMMARY OF INVENTION

A package for an optical fiber according to the present disclosure is
a package configured to house an optical fiber having a connector mounted to at least one end of the optical fiber, the package including:
a base having a flat surface;
a plurality of protrusions protruding from the flat surface of the base and arranged along an outer periphery of the base;
a first mounting portion to which the connector of the optical fiber is mounted; and
a plurality of falling-off prevention portions configured to regulate a position of the optical fiber, in which
the plurality of protrusions are configured such that the optical fiber is wound along a part of an outer periphery of each of the plurality of protrusions, and
the first mounting portion includes a locking portion provided such that the first mounting portion is locked to an outer peripheral edge of the base or the optical fiber.

A package product according to the present disclosure includes:
an optical fiber having a connector mounted to at least one end of the optical fiber; and
the package for an optical fiber, in which
the optical fiber is housed in the package for an optical fiber,
the connector is mounted to the first mounting portion, and
the first mounting portion is locked to the outer peripheral edge of the base or the optical fiber wound around the plurality of protrusions.

An optical fiber lead-out method according to the present disclosure is
a method for leading out an optical fiber having a connector mounted to at least one end of the optical fiber from a package product around which the optical fiber is wound and in which the connector is locked in a vicinity of an outer periphery of a package, the method including:
a of removing the connector of the optical fiber from each of a plurality of the package products;
a of stacking the plurality of package products and attaching the stacked package products to a rotatable fixture; and
a of collectively pulling the connectors respectively removed from the plurality of package products attached to the fixture or a part of the optical fibers connected to the connectors.

An optical fiber lead-out method according the present disclosure is a method for leading out an optical fiber using a fixture from a package product, the package product being a package product in which an optical fiber having a connector mounted to at least one end of the optical fiber is wound around the package for an optical fiber, and in the package product, the connector being locked to the outer peripheral edge of the base or the optical fiber wound around the plurality of protrusions, in which
the fixture includes
   a shaft to which the package is attached,
   a support portion provided on the shaft and having a placement surface that allows placement of the package,
   a gripped portion configured to rotatably support the shaft, and
   a contact portion provided at an end of the shaft and having a contact surface that comes into contact with the gripped portion when the shaft part is displaced in a rotational axis direction with respect to the gripped portion, and
the method includes:
a of removing the connector of the optical fiber from each of a plurality of the package products;
a of stacking the plurality of package products and attaching the stacked package products to the fixture; and
a of collectively pulling the connectors respectively removed from the plurality of package products attached to the fixture or a part of the optical fibers connected to the connectors.

### BRIEF DESCRIPTION OF DRAWINGS

FIG. 1 is a perspective view of a package for an optical fiber according to a first embodiment of the present disclosure.

FIG. 2 is a perspective view showing a back surface of the package shown in FIG. 1.

FIG. 3 is a perspective view showing a first mounting portion separated from the package shown in FIG. 1.

FIG. 4 is a cross-sectional view of the first mounting portion shown in FIG.

3.

FIG. 5 is an enlarged schematic view of a second mounting portion of the package shown in FIG. 1.

FIG. 6 is an enlarged schematic view of the second mounting portion of the package shown in FIG. 1.

FIG. 7 is a top view of a package product for an optical fiber according to the first embodiment of the present disclosure.

FIG. 8 is a cross-sectional view cleaved along a line A-A shown in FIG. 7.

FIG. 9 is a perspective view showing a first mounting portion of a package for an optical fiber according to a second embodiment of the present disclosure.

FIG. 10 is a perspective view showing a modification of the first mounting portion shown in FIG. 9.

FIG. 11 is a perspective view of a package product for an optical fiber according to the second embodiment of the present disclosure.

FIG. 12 is an enlarged schematic view of the first mounting portion of the package product shown in FIG. 11.

FIG. 13 is a cross-sectional view cleaved along a line B-B shown in FIG. 11.

FIG. 14 is a perspective view showing a first mounting portion of a package for an optical fiber according to a third embodiment of the present disclosure.

FIG. 15 is a perspective view of a package product for an optical fiber according to the third embodiment of the present disclosure.

FIG. 16 is a cross-sectional view cleaved along a line C-C shown in FIG. 15.

FIG. 17 is a perspective view of a multi-stacking fixture used for leading out an optical fiber from the package product.

FIG. 18 is a perspective view showing a state in which the package product is attached to the multi-stacking fixture shown in FIG. 17.

FIG. 19 is a schematic view for explaining a method for leading out an optical fiber from a plurality of package products using the multi-stacking fixture in FIG. 17.

### DESCRIPTION OF EMBODIMENTS

### Problem to be Solved by Present Disclosure

In the housing cases disclosed in Patent Literatures 1 and 2, the fixing positions of the connectors provided at both ends of the optical fiber are fixed. Therefore, depending on a winding method of the optical fiber, the connectors may not reach the fixing positions, or needless optical fibers may be remained near the fixing positions. In such cases, it takes time and effort to rewind the optical fiber or to carefully press the needless optical fibers into the housing case, and therefore, the housing cases disclosed in Patent Literature 1 and Patent Literature 2 have room for improvement in workability.

An object of the present disclosure is to provide a package for an optical fiber, a package product, and an optical fiber lead-out method with high workability.

### Description of Embodiments of Present Disclosure

First, contents of embodiments of the present disclosure will be listed and described.
(1) A package for an optical fiber according to one aspect of the present disclosure is
a package configured to house an optical fiber having a connector mounted to at least one end of the optical fiber, the package including:
a base having a flat surface;
a plurality of protrusions protruding from the flat surface of the base and arranged along an outer periphery of the base;
a first mounting portion to which the connector of the optical fiber is mounted; and
a plurality of falling-off prevention portions configured to regulate a position of the optical fiber, in which
the plurality of protrusions are configured such that the optical fiber is wound along a part of an outer periphery of each of the plurality of protrusions, and
the first mounting portion includes a locking portion provided such that the first mounting portion is locked to an outer peripheral edge of the base or the optical fiber.

According to this configuration, a package for an optical fiber with high workability can be provided. Specifically, by the locking portion provided to lock the first mounting portion to the outer peripheral edge of the base or the optical fiber, a situation in which the connector does not reach the fixing position or a needless optical fiber is remained near the fixing position as in the case of using the housing cases of Patent Literatures 1 and 2 will not occur. As a result, workability can be improved since there is no need to rewind the optical fiber or to carefully press the needless optical fiber into the housing case.

(2) In the package for an optical fiber according to the above (1),
the locking portion may be provided such that the first mounting portion is locked to the outer peripheral edge of the base,
the first mounting portion may include a first connector fixing portion for fixing the connector, and
the first connector fixing portion may have a C-shaped cross section and may be configured to mount the connector in a space connected to an opening.

According to this configuration, a package for an optical fiber having a simple structure and high workability can be provided.

(3) In the package for an optical fiber according to the above (2),
the first mounting portion may include two or more locking portions, and
the first mounting portion may further include
   the first connector fixing portion for fixing a rear end of the connector, and
   a second connector fixing portion for fixing the other portion of the connector different from the rear end.

According to this configuration, the first mounting portion can be more strongly fixed to the base. The connector can be more strongly fixed to the first mounting portion.

(4) In the package for an optical fiber according to the above (1),
the locking portion may lock the first mounting portion to the optical fiber by being inserted between a part of the optical fiber wound around the plurality of protrusions and the other part of the optical fiber, or between the optical fiber and the base.
According to this configuration, a package for an optical fiber having a simple structure and high workability can be provided.

(5) The package for an optical fiber according to any one of the above (1) to (4) may further include:
the second mounting portion different from the first mounting portion, in which
the second mounting portion may be constituted by a pair of gripping portions positioned closer to a center of the base than the plurality of protrusions, the pair of gripping portions protruding from the flat surface of the base and being arranged to face each other in a first direction that intersects a direction in which the pair of gripping portions protrude from the flat surface of the base.

According to this configuration, the connector provided at one end of the optical fiber can be strongly fixed to the second mounting portion. Since the second mounting portion is positioned closer to the center of the base than the plurality of protrusions, the second mounting portion does not become an obstacle when the optical fiber is wound around the plurality of protrusions, and thus workability can be further improved.

(6) The package for an optical fiber according to any one of the above (1) to (5) may further include:
a rib protruding from the flat surface of the base and provided along the outer peripheral edge of the base.

According to this configuration, deformation of the base during molding or due to aging can be prevented. When the locking portion is capable of being locked to the outer peripheral edge of the base, for example, by forming the locking portion into a shape capable of engaging with the rib, the locking portion can be strongly locked to the outer peripheral edge with a simple structure.

(7) In the package for an optical fiber according to any one of the above (1) to (6),
a portion corresponding to each of the plurality of protrusions on the outer periphery of the base may extend toward an outer side than the other portion on the outer periphery of the base.

According to this configuration, it is possible to reduce a possibility that the optical fiber wound around the plurality of protrusions falls off the package.

(8) In the package for an optical fiber according to any one of the above (1) to (7),
the first mounting portion is integrally molded with the base, and is easily separable.

According to this configuration, manufacturing becomes easy, and a manufacturing cost can be reduced.

(9) A package product according to one aspect of the present disclosure includes:
an optical fiber having a connector mounted to at least one end of the optical fiber; and
the package for an optical fiber according to any one of the above (1) to (8), in which
the optical fiber is housed in the package for an optical fiber,
the connector is mounted to the first mounting portion, and
the first mounting portion is locked to the outer peripheral edge of the base or the optical fiber wound around the plurality of protrusions.

The present disclosure provides an optical fiber housed in a single package, and the optical fiber can be easily led out from the package. It is also easy to lock and remove the connector to and from the package.

(10) An optical fiber lead-out method according to one aspect of the present disclosure is
a method for leading out an optical fiber having a connector mounted to at least one end of the optical fiber from a package product around which the optical fiber is wound and in which the connector is locked in a vicinity of an outer periphery of a package, the method including:
a of removing the connector of the optical fiber from each of a plurality of the package products;
a of stacking the plurality of package products and attaching the stacked package products to a rotatable fixture; and
a of collectively pulling the connectors respectively removed from the plurality of package products attached to the fixture or a part of the optical fibers connected to the connectors.

According to the present disclosure, when the connector or a part of the optical fiber is pulled, the package rotates together with the fixture, so that the optical fiber can be easily led out from the package. The optical fibers can be collectively led out from the plurality of packages by one pulling operation. Since the connector is locked the vicinity of the outer periphery of the package, the connector can be removed both before and after the package is attached to the fixture. Therefore, a degree of freedom of work is increased.

(11) An optical fiber lead-out method according to one aspect of the present disclosure is

a method for leading out an optical fiber using a fixture from a package product, the package product being a package product in which an optical fiber having a connector mounted to at least one end of the optical fiber is wound around the package for an optical fiber according to any one of the above (1) to (8), and in the package product, the connector being locked to the outer peripheral edge of the base or the optical fiber wound around the plurality of protrusions, in which
the fixture includes
   a shaft to which the package is attached,
   a support portion provided on the shaft and having a placement surface that allows placement of the package,
   a gripped portion configured to rotatably support the shaft, and
   a contact portion provided at an end of the shaft and having a contact surface that comes into contact with the gripped portion when the shaft part is displaced in a rotational axis direction with respect to the gripped portion, and
the method includes:
a of removing the connector of the optical fiber from each of a plurality of the package products;
a of stacking the plurality of package products and attaching the stacked package products to the fixture; and
a of collectively pulling the connectors respectively removed from the plurality of package products attached to the fixture or a part of the optical fibers connected to the connectors.

According to the present disclosure, when the connector or a part of the optical fiber is pulled, the package rotates together with the fixture, so that the optical fiber can be easily led out from the package. The optical fibers can be collectively led out from the plurality of packages by one pulling operation. Since the connector is locked the vicinity of the outer periphery of the package, the connector can be removed both before and after the package is attached to the fixture. Therefore, a degree of freedom of work is increased.

### Advantageous Effects of Present Disclosure

According to the present disclosure, a package for an optical fiber, a package product, and an optical fiber lead-out method with high workability can be provided.

### DETAILS OF EMBODIMENTS OF PRESENT DISCLOSURE

Hereinafter, embodiments of the present disclosure will be described in detail with reference to the accompanying drawings. Dimensions of members shown in the drawings may be different from actual dimensions of the members for convenience of description. Note that the present disclosure is not limited to these exemplifications, but is indicated by the scope of claims, and is intended to include all modifications within a scope and meanings equivalent to the scope of claims.

### First Embodiment

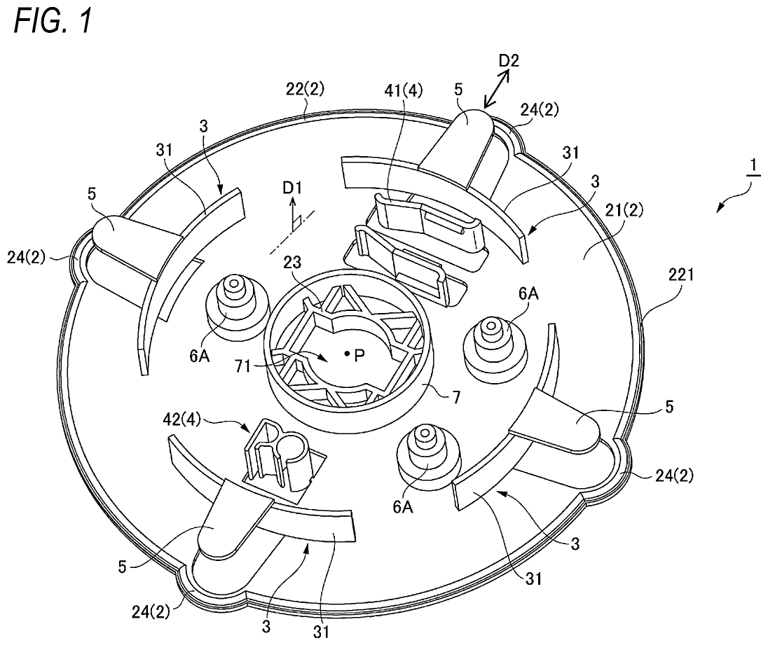

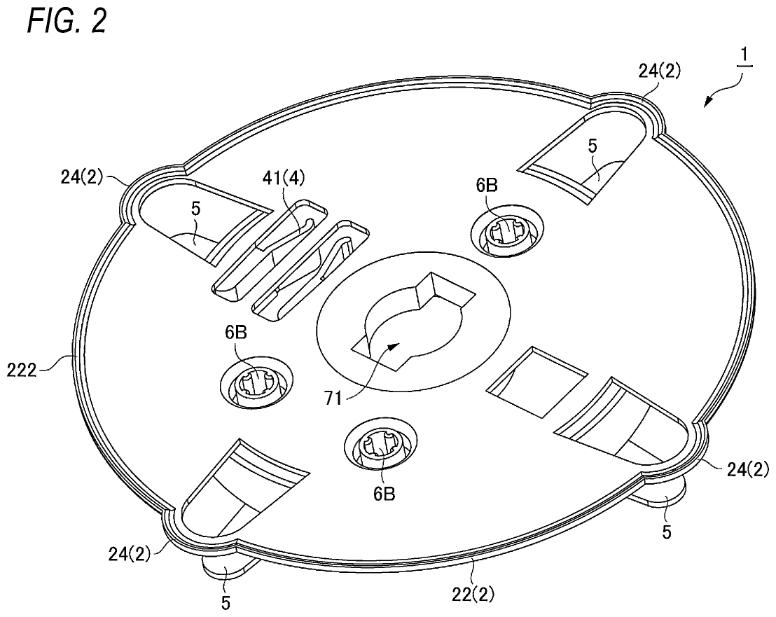

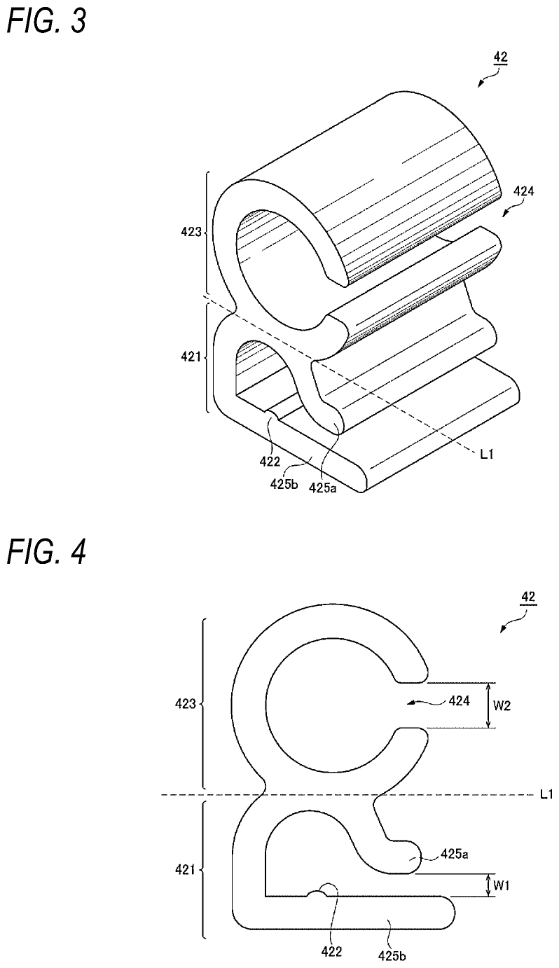

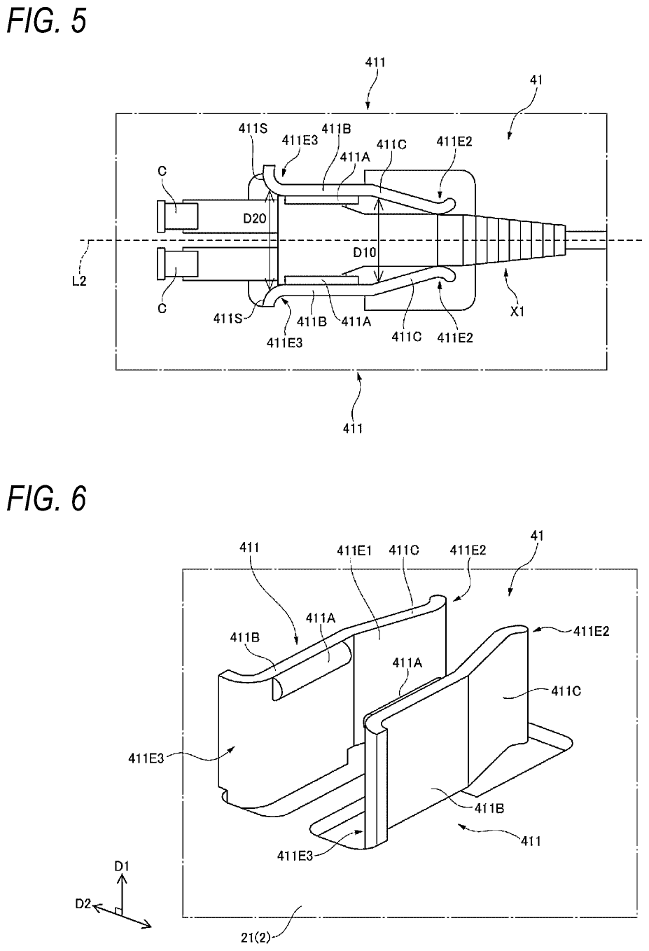

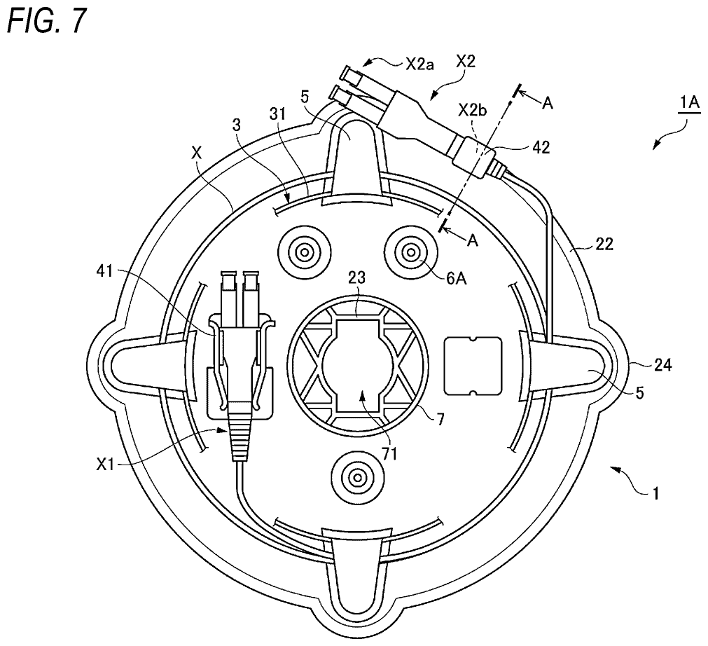

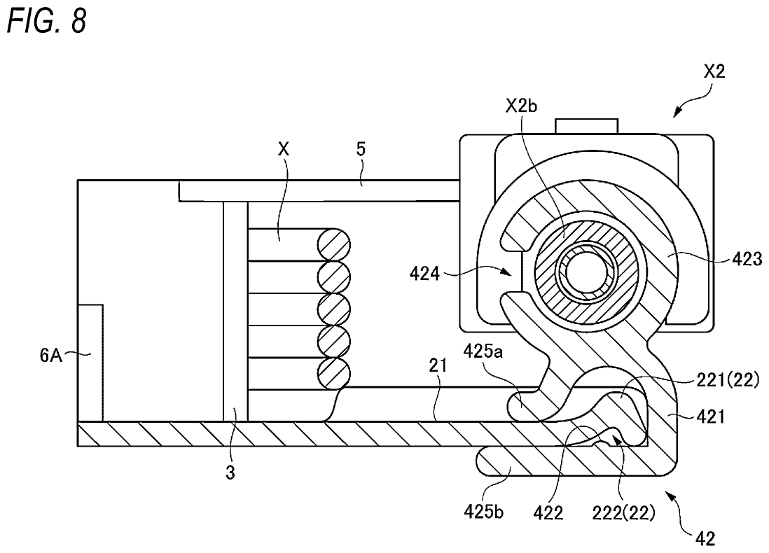

First, a first embodiment will be described with reference to FIGS. 1 to 8. FIG. 1 is a perspective view of a package 1 for an optical fiber according to the first embodiment of the present disclosure. FIG. 2 is a perspective view showing a back surface of the package 1 shown in FIG. 1. FIG. 3 is a perspective view showing a first mounting portion 42 separated from the package 1 shown in FIG. 1. FIG. 4 is a cross-sectional view of the first mounting portion 42 shown in FIG. 3. FIGS. 5 and 6 are enlarged schematic views of a second mounting portion 41 of the package 1 shown in FIG. 1. FIG. 7 is a top view of a package product 1A for an optical fiber according to the first embodiment. FIG. 8 is a cross-sectional view cleaved along a line A-A shown in FIG. 7. Note that in the following description, the surface shown in FIG. 1 is also referred to as a first surface, and the surface shown in FIG. 2 (a back surface of the first surface) is also referred to as a second surface.

As shown in FIGS. 1 and 2, the package 1 includes a base 2 having a flat surface 21, a plurality of protrusions 3, a mounting portion 4, a plurality of falling-off prevention portions 5, connection portions 6A and 6B, and a central protrusion 7. In the present embodiment, an arrow D1 indicates a direction (hereinafter, referred to as a direction D1) perpendicular to the flat surface 21 of the base 2. An arrow D2 indicates a direction (hereinafter, referred to as a direction D2) intersecting the direction D1 (perpendicular to the direction D1).

Note that as shown in FIG. 7, the package 1 is configured to house an optical fiber X having a connector mounted to at least one end of the optical fiber X in a wound state. The optical fiber X in the present embodiment is an optical fiber with connectors having a first connector X2 and a second connector X1 at both ends. The first connector X2 and the second connector X1 in the present embodiment have the same shape, but may have different shapes.

When the optical fiber X has only one connector, the end having no connector is formed to be capable of fusion splicing to another optical fiber or optical components, for example. In this case, it is preferable that the package 1 includes a portion for detachably fixing the end having no connector.

The description returns to FIGS. 1 and 2. The base 2 is a flat plate serving as a base of the package 1, and includes the flat surface 21 and an outer peripheral edge 22. A thickness of the base 2 is, for example, 1.0 mm to 3.0 mm. A material of the base 2 is, for example, a synthetic resin such as polypropylene. A shape of the base 2 may be a circular shape, an elliptical shape, a rectangular shape with rounded corners, a square shape, a rectangular shape, or a polygonal shape in a plan view of the base 2. From the viewpoint of space saving, the shape of the base 2 preferably is a circular shape in the plan view of the base 2.

The outer peripheral edge 22 is an outer periphery portion of the base 2. The outer peripheral edge 22 is provided with a rib 221, a concave portion 222, and an extending portion 24. As shown in FIG. 1, the rib 221 is provided along the outer peripheral edge 22 on the first surface of the base 2. The rib 221 is formed to rise in the direction D1 from the flat surface 21 of the base 2. As shown in FIG. 2, the concave portion 222 is provided along the outer peripheral edge 22 on the second surface of the base 2. The extending portion 24 is provided at a portion corresponding to the protrusions 3 on the outer periphery of the base 2. The extending portion 24 extends outward from the other portion of the outer periphery of the base 2. In other words, the extending portion 24 is formed to have a longer distance from a base center P than the other portion of the outer periphery of the base 2.

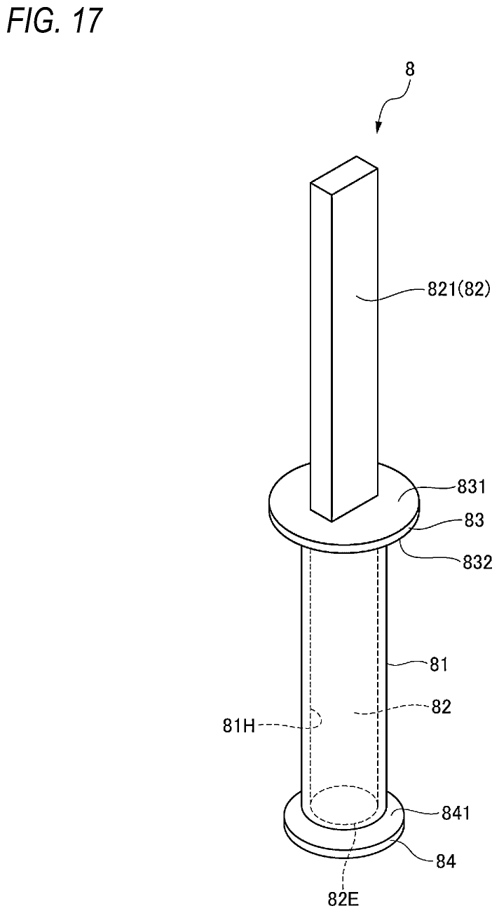

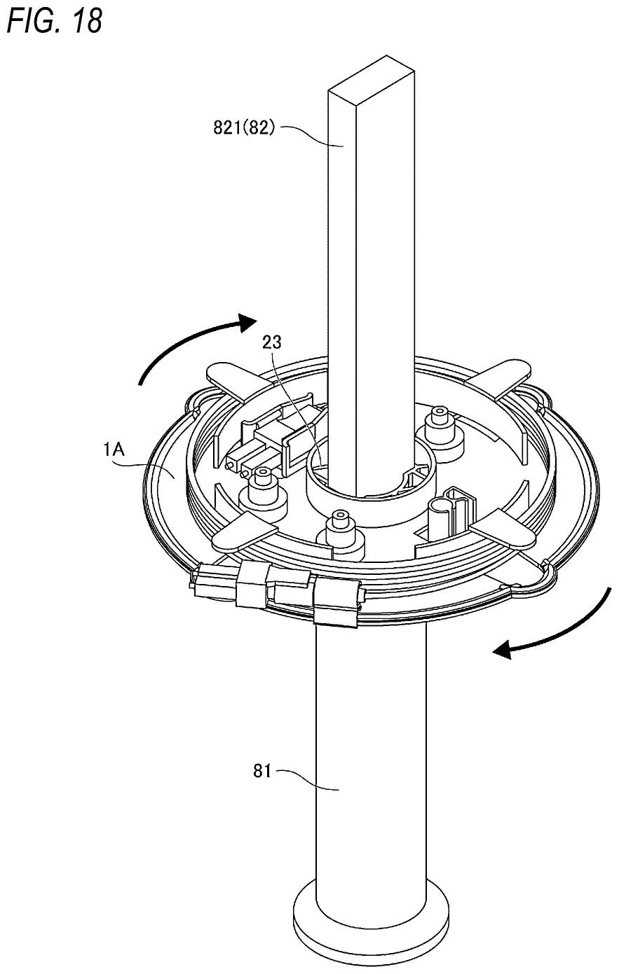

A guide wall 23 is formed near the center of the base 2. An insertion hole 71 is formed inside the guide wall 23. The insertion hole 71 has a non-circular shape in the plan view of the base 2 and penetrates the base 2. A multi-stacking fixture 8 (see FIG. 17) to be described later is inserted through the insertion hole 71.

The plurality of protrusions 3 are formed to protrude from the flat surface 21 of the base 2, and are disposed along the outer periphery of the base. The optical fiber X is wound around the plurality of protrusions 3 on the flat surface 21 along a part of the outer periphery of each protrusion 3 (see FIG. 7). In the present embodiment, four protrusions 3 are disposed on the flat surface 21 in a manner of being separated from each other. The optical fiber X is wound in a circular shape along outer peripheral surfaces 31 of the four protrusions 3. Here, “along the outer peripheral surface 31” does not only refer to a state where the optical fiber X is in direct contact with the outer peripheral surfaces 31 of the protrusions 3, but may also refer to a state where the optical fiber X is wound in a circular shape having a curvature radius equal to or greater than that of the outer peripheral surfaces 31. The plurality of protrusions 3 may be integrally formed with the base 2. Here, the expression “integrally formed” used in the present specification means made of a single member (that is, forming to have a monolithic structure). The plurality of protrusions 3 may be molded together with the base 2 by injection molding of a synthetic resin such as polypropylene using a mold, for example. The outer peripheral surface 31 of each protrusion 3 may have an arc shape in the plan view of the base 2. The outer peripheral surface 31 may be perpendicular to the flat surface 21 of the base 2. Although four protrusions 3 are formed in the package 1, the number of the protrusions 3 is not limited to four. The package 1 may include the plurality of protrusions 3 according to an allowable curvature radius of the optical fiber.

Each falling-off prevention portion 5 is integrally formed with the base 2. Each falling-off prevention portion 5 is configured to regulate a position of the optical fiber X wound around the plurality of protrusions 3. Specifically, each falling-off prevention portion 5 is configured to regulate the position of the optical fiber X in the direction D1 perpendicular to the flat surface 21 of the base 2. Each falling-off prevention portion 5 extends in a direction along the flat surface 21 of the base 2. In the present embodiment, each falling-off prevention portion 5 is formed integrally with the protrusion 3, and extends in a direction toward the outside of the base 2 from a front end of the protrusion 3 in a direction protruding from the flat surface 21 of the base 2. A length of the falling-off prevention portion 5 can be appropriately set to a dimension such that the optical fibers X wound around the plurality of protrusions 3 are covered by the falling-off prevention portion 5 in the plan view of the base 2 for example.

As shown in FIG. 1, in the package 1, three connection portions 6A are arranged as the plurality of connection portions 6A. In the plan view of the base 2, the three connection portions 6A are arranged at positions corresponding to vertices of a triangle including the base center P therein. For example, the three connection portions 6A may be arranged at the vertices of the triangle that is symmetrical with respect to a line passing through the center of the base 2. Alternatively, the three connection portions 6A may be arranged such that a center of gravity of the triangle is positioned at the center of the base 2. Note that when four or more connection portions 6A are arranged in the package 1, at least three connection portions 6A are arranged at positions corresponding to vertices of a triangle including the base center P therein.

Each connection portion 6A protrudes from the flat surface 21 of the base 2. On the other hand, as shown in FIG. 2, at least a part of each connection portion 6B formed on a back side of each connection portion 6A is recessed in a direction from the second surface toward the first surface. At least a part of a protrusion of the connection portion 6A can be fitted to at least a part of a concave portion of the connection portion 6B. That is, the package 1 can be stacked with the other package 1 on the first surface side by fitting each connection portion 6A into each connection portions 6B of the other package 1. Similarly, the package 1 can be stacked with the other package 1 on the second surface side by fitting each connection portion 6B into each connection portion 6A of the other package 1.

Referring back to FIG. 1, the package 1 may include the central protrusion 7 protruding from the flat surface 21 of the base 2 and disposed closer to the base center P than the plurality of protrusions 3. In the present embodiment, since the remaining portion of the optical fiber X wound around the plurality of protrusions 3 can be wound around an outer periphery of the central protrusion 7, the extra length of the optical fiber X can be easily adjusted. The central protrusion 7 is formed to surround the guide wall 23. The central protrusion 7 may be formed integrally with the base 2. The central protrusion 7 may be molded together with the base 2, the plurality of protrusions 3, the mounting portion 4, the plurality of falling-off prevention portions 5, and the plurality of connection portions 6 by injection molding a synthetic resin such as polypropylene using a mold, for example.

The package 1 includes the mounting portion 4 to which the connector of the optical fiber X is mounted. In the present embodiment, the package 1 includes the first mounting portion 42 and the second mounting portion 41 as the mounting portion 4. Therefore, a winding state of the optical fiber X can be stabilized.

As shown in FIG. 1, the first mounting portion 42 may be integrally formed with the base 2. The first mounting portion 42 may be molded together with the base 2 and the plurality of protrusions 3 by injection molding a synthetic resin such as polypropylene using a mold, for example. When the first mounting portion 42 is integrally molded with the base 2, the first mounting portion 42 is preferably easily separable from the base 2. In the example of FIG. 1, the first mounting portion 42 can be easily separated from the base 2 by, for example, applying a force in the D1 direction.

As described above, in the package 1 of the present disclosure, since the falling-off prevention portions 5 are integrally formed with the base 2, the optical fiber X can be prevented from falling off by the package alone. Accordingly, the present disclosure can provide a package having a simple structure as compared with a case where the optical fiber X is prevented from falling off by a plurality of members.

FIGS. 3 and 4 show the first mounting portion 42 separated from the base 2. In the present embodiment, the first connector X2 is mounted to the first mounting portion 42 (see FIG. 7). As shown in FIGS. 3 and 4, the first mounting portion 42 includes a locking portion 421 and a connector fixing portion 423. The locking portion 421 is a portion below a line L1 in FIGS. 3 and 4 on the page, and is configured to lock the first mounting portion 42 to the outer peripheral edge 22 of the base 2. The locking portion 421 is made of an elastically deformable material. The locking portion 421 includes a rib 422 and a pair of opposing clamping portions 425a and 425b. In a state where the first mounting portion 42 is not locked to the outer peripheral edge 22, a width W1 between the clamping portions 425a and 425b is preferably smaller than the thickness of the base 2. A state where the first mounting portion 42 is locked to the outer peripheral edge 22 will be described later with reference to FIGS. 7 and 8. The connector fixing portion 423 is an example of a first connector fixing portion.

The connector fixing portion 423 is a portion above the line L1 on the page. The connector fixing portion 423 has a C-shaped cross section, and the first connector X2 can be mounted in a space connected to the opening. Note that the expression “C-shaped” in the present specification refers to a closed figure provided with one or more openings. In the present embodiment, the connector fixing portion 423 has a cylindrical shape having a slit as an opening. The connector fixing portion 423 is made of an elastically deformable material. An inner diameter of the connector fixing portion 423 is smaller than at least a part of a diameter of the first connector X2. The slit functions as an optical fiber passage portion 424 for passing the optical fiber X in a state where no force is applied to the connector fixing portion 423 or in a state where the connector fixing portion 423 is elastically deformed. It is preferable that a width W2 of the optical fiber passage portion 424 is a size through which at least a part of the first connector X2 cannot pass. A state in which the first connector X2 is mounted to the first mounting portion 42 will be described later with reference to FIGS. 7 and 8.

FIGS. 5 and 6 show the second mounting portion 41. In the present embodiment, the second connector X1 of the optical fiber X is mounted to the second mounting portion 41. The second mounting portion 41 may be integrally formed with the base 2. The second mounting portion 41 may be molded together with the base 2 and the plurality of protrusions 3 by injection molding a synthetic resin such as polypropylene using a mold, for example.

As shown in FIG. 5, the second mounting portion 41 is formed to engage with the second connector X1. Specifically, the second mounting portion 41 includes a pair of gripping portions 411. As shown in FIG. 6, the pair of gripping portions 411 protrude from the flat surface 21 of the base 2 in the direction D1 perpendicular to the flat surface 21 of the base 2. The pair of gripping portions 411 are disposed to face each other in a direction (first direction) D2 perpendicular to the direction D1. In other words, the second connector X1 is held between the pair of gripping portions 411 in the direction D2. The pair of gripping portions 411 are closer to the base center P than the plurality of protrusions 3.

As shown in FIG. 6, each gripping portion 411 has a convex portion 411A protruding toward the other gripping portion 411 at a front end 411E1 in a direction protruding from the flat surface 21 of the base 2. Note that in the present embodiment, both the pair of gripping portions 411 have the convex portions 411A, but only one of the pair of gripping portions 411 may have the convex portion 411A.

Each gripping portion 411 extends in a direction along a line L2, which is a longitudinal direction of the second connector X1, and includes a first end 411E2 and a second end 411E3 in this direction. Each gripping portion 411 includes a connection portion 411B coupled to the base 2 and a non-connection portion 411C not coupled to the base 2. In a plan view shown in FIG. 5, a hole is provided in a region of the base 2 where the non-connection portion 411C is provided.

An interval D10 in the direction D2 between the non-connection portions 411C of the pair of gripping portions 411 decreases toward the first end 411E2. An interval D20 in the direction D2 between the gripping portions 411 in the second end 411E3 increases toward a distal end of the second end 411E3. In the present embodiment, a surface 411S of the second end 411E3 of the gripping portion 411 facing the other gripping portion 411 is curved in the plan view of the base 2 (FIG. 5).

Since the second connector X1 of the optical fiber X is held in a state of being sandwiched by the pair of gripping portions 411 in the direction D2, when the second connector X1 is removed from the second mounting portion 41, the second connector X1 can be removed from the direction DI or a direction intersecting the direction D1 and the direction D2.

Since the gripping portion 411 has the convex portion 411A protruding toward the other gripping portion 411 at the front end 411E1, for example, when the package 1 vibrates due to an external force, the second connector X1 can be prevented from being detached from the second mounting portion 41 in the direction D1.

Since the interval D10 between the non-connection portions 411C of the pair of gripping portions 411 is narrower toward the first end 411E2, the second connector X1 can be sandwiched between the pair of non-connection portions 411C. Accordingly, for example, when the package 1 vibrates due to an external force, the second connector X1 can be prevented from being detached from the second mounting portion 41 in the direction D2 or a direction intersecting the direction D1 and the direction D2. By deforming the non-connection portions 411C, the second connector X1 is easily attached to the second mounting portion 41, and the second connector X1 is easily removed from the second mounting portion 41.

Since the interval D20 between the gripping portions 411 in the second end 411E3 increases toward the distal end of the second end 411E3, when the second connector X1 is detached from the second mounting portion 41 in the direction intersecting the direction D1 and the direction D2, a cap C attached to a distal end of the second connector X1 can be prevented from coming into contact with the second end 411E3 of the gripping portion 411 and falling off from the second connector X1.

Since the surface 411S of the second end 411E3 facing the other gripping portion 411 is curved in the plan view of the base 2, the cap C can be guided along the curved surface 411S even when the cap C of the second connector X1 comes into contact with the second end 411E3 when the second connector X1 is removed from the second mounting portion 41 in the direction intersecting the direction D1 and the direction D2.

FIG. 7 shows the package product 1A for an optical fiber. In the package product 1A, the optical fiber X having a connector mounted to at least one end of the optical fiber X is housed in the package 1. In the present embodiment, the package product 1A houses the optical fiber X having one end to which the first connector X2 is mounted and the other end to which the second connector X1 is mounted. In the package product 1A, the second connector X1 is mounted to the second mounting portion 41 in the same state as in FIG. 5. The optical fiber X is wound around the plurality of protrusions 3. In the first connector X2, a connector rear end X2b is mounted to the first mounting portion 42, and the first mounting portion 42 is locked to the outer peripheral edge 22. Note that a connector distal end X2a is a side on which the first connector X2 is connected to an external device or the like, and the connector rear end X2b is an end on an opposite side to the connector distal end X2a of the first connector X2.

Here, mounting of the first connector X2 to the first mounting portion 42 and locking of the first mounting portion 42 to the outer peripheral edge 22 will be described with reference to FIG. 8. When the first connector X2 is mounted to the first mounting portion 42, the optical fiber X is inserted into the connector fixing portion 423 by passing the optical fiber X through the optical fiber passage portion 424, and then the connector rear end X2b of the first connector X2 is pressed into the connector fixing portion 423 from a back direction to a front direction of the page of FIG. 8. In the present embodiment, since an inner diameter of the connector fixing portion 423 is smaller than at least a part of a diameter of the connector rear end X2b of the first connector X2, the connector fixing portion 423 fixes the connector rear end X2b by a restoring force while being elastically deformed and expanded.

When the first mounting portion 42 is locked to the outer peripheral edge 22, the clamping portions 425a and 425b are elastically deformed in directions away from each other, and the outer peripheral edge 22 including the rib 221 and the concave portion 222 is inserted into the locking portion 421. In this state, when a force is applied to move the first mounting portion 42 in a direction parallel to the flat surface 21 and away from the base center P, the rib 221 and the clamping portions 425a come into contact with each other, and/or the rib 422 and the concave portion 222 come into contact with each other, so as to prevent the first mounting portion 42 from moving in this direction. That is, in the above-described state, the first mounting portion 42 is locked to the outer peripheral edge 22. When a force is further applied in this state, the clamping portions 425a and 425b are elastically deformed in directions away from each other, and the locking is released.

Note that when the width W1 (see FIG. 4) between the clamping portions 425a and 425b is smaller than the thickness of the base 2 in a state where the outer peripheral edge 22 including the rib 221 and the concave portion 222 is not inserted into the locking portion 421, the base 2 is clamped by the restoring forces of the clamping portions 425a and 425b. Therefore, the first mounting portion 42 can be more strongly locked to the outer peripheral edge 22, and in this state, the position of the first mounting portion 42 is less likely to be displaced.

### Second Embodiment

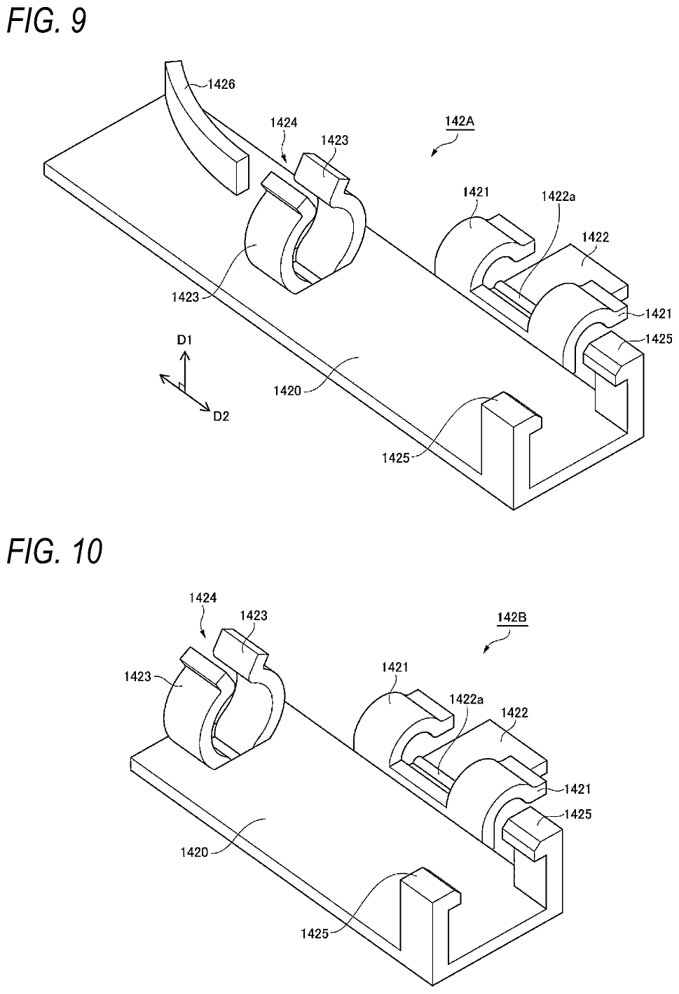

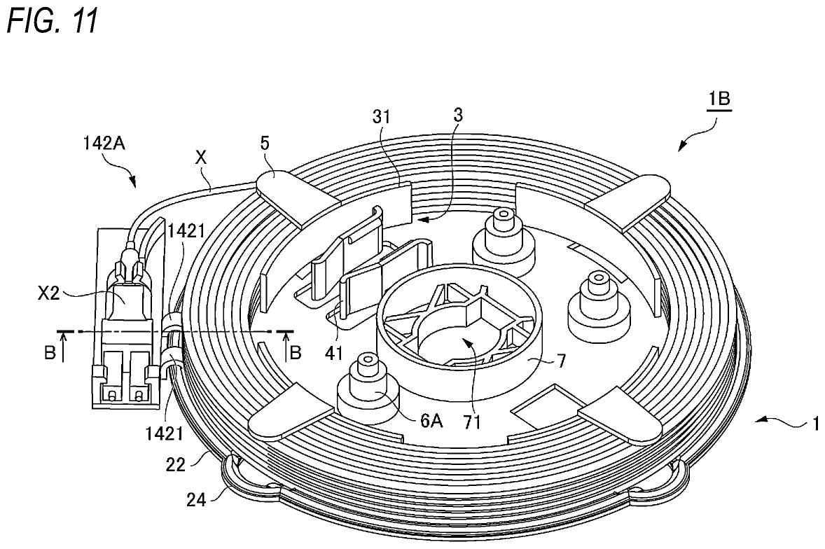

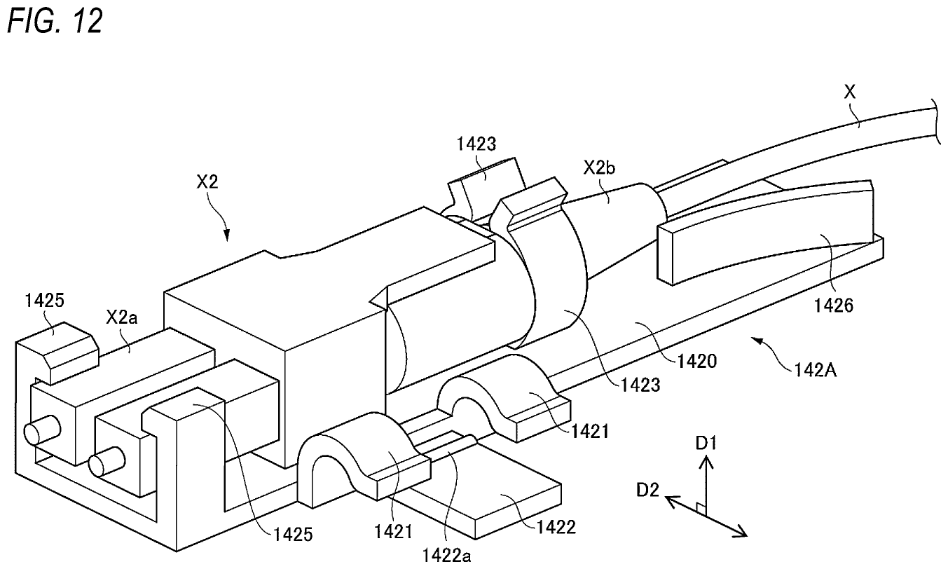

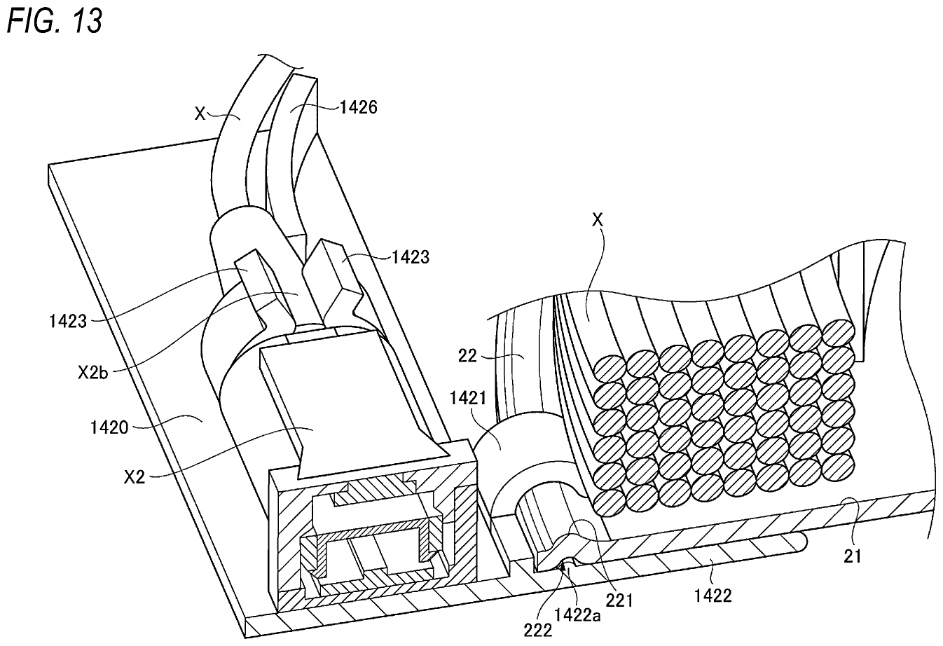

A second embodiment will be described in detail with reference to FIGS. 9 to 13. FIG. 9 is a perspective view showing a first mounting portion 142A of a package for an optical fiber according to the second embodiment of the present disclosure. FIG. 10 is a perspective view showing a modification of the first mounting portion 142A shown in FIG. 9. FIG. 11 is a perspective view of a package product 1B for an optical fiber according to the second embodiment. FIG. 12 is an enlarged schematic view of the first mounting portion 142A of the package product 1B shown in FIG. 11. FIG. 13 is a cross-sectional view cleaved along a line B-B shown in FIG. 11.

Note that the package 1 according to the second embodiment may be the same as the package 1 according to the first embodiment except that the first mounting portion 142A or 142B is provided instead of the first mounting portion 42. In the first mounting portions 142A and 142B, members having the same names as those of the first mounting portion 42 may have the same functions as those of the first mounting portion 42. Therefore, the description of the same portions as in the first embodiment will be appropriately omitted. In the second embodiment, the contents described in the first embodiment can be applied within a range in which no contradiction occurs.

As shown in FIG. 9, the first mounting portion 142A includes a flat surface 1420, two locking portions 1421, a locking portion 1422, a pair of connector fixing portions 1423, a pair of connector fixing portions 1425, and a guide portion 1426. The first mounting portion 142A is made of an elastically deformable material.

The two locking portions 1421 are provided in a manner of being curved from an end of the flat surface 1420 toward the direction D1. The locking portion 1422 is provided between the two locking portions 1421 and extending from the end of the flat surface 1420. The locking portion 1422 includes a rib 1422a provided along a longitudinal direction of the first mounting portion 142A. When the two locking portions 1421 and the locking portion 1422 are viewed from a direction parallel to the longitudinal direction of the first mounting portion 142A, they have the same shape as the cross section of the locking portion 421 of the first mounting portion 42 in the first embodiment.

The pair of connector fixing portions 1423 have C-shaped cross sections and fix the connector rear end X2b therein. The cross sections of the pair of connector fixing portions 1423 are closed circles with two slits, which is included in the definition of “C-shaped”. An optical fiber passage portion 1424 is formed between the pair of connector fixing portions 1423. The pair of connector fixing portions 1423 is an example of the first connector fixing portion.

The pair of connector fixing portions 1425 protrude from the flat surface 1420 in the direction D1. The pair of connector fixing portions 1425 can fix the connector distal end X2a. Note that the connector fixing portion 1425 may fix an intermediate portion between the connector distal end X2a and the connector rear end X2b. The pair of connector fixing portions 1425 constitute an example of a second connector fixing portion. The first mounting portion 142A may include only one of the pair of connector fixing portions 1423 and the pair of connector fixing portions 1425, or may further include another connector fixing portion.

The guide portion 1426 protrudes from the flat surface 1420 in the direction D1. The guide portion 1426 has a surface having an arc shape in a plan view, and guides the optical fiber X extending from the first connector X2 along the surface in any direction of the plurality of protrusions 3. By providing the guide portion 1426, it is possible to reduce a load applied to the optical fiber X in the vicinity of the first connector X2 in a state where the optical fiber X is housed in the package 1.

A first mounting portion 142B shown in FIG. 10 is a modification of the first mounting portion 142A. The first mounting portion 142B is configured similarly to the first mounting portion 142A except that the guide portion 1426 is not provided. The first mounting portion 142B does not include the guide portion 1426, and therefore is more easily manufactured and less expensive than the first mounting portion 142A.

FIG. 11 shows the package product 1B for an optical fiber according to the second embodiment. In the package product 1B, the optical fiber X having a connector mounted to at least one end of the optical fiber X is housed in the package 1. Similarly to the first embodiment, the package product 1B houses the optical fiber X having one end to which the first connector X2 is mounted and the other end to which the second connector X1 is mounted, but the second connector X1 is omitted in the drawing. In the package product 1B, the first connector X2 is mounted to the first mounting portion 142A. The first mounting portion 142A is locked to the outer peripheral edge 22.

FIG. 12 shows the first mounting portion 142A in a state where the first connector X2 is mounted. The pair of connector fixing portions 1423 houses the connector rear end X2b therein. In this state, movement of the connector rear end X2b in the direction D1 and the direction D2 is prevented. Note that by elastically deforming the pair of connector fixing portions 1423 in directions away from each other, the connector rear end X2b can be mounted and removed.

The pair of connector fixing portions 1425 fix the connector distal end X2a. A distance between the pair of connector fixing portions 1425 is equal to or slightly longer than a length of the connector distal end X2a in the D2 direction. Each connector fixing portion 1425 has a portion protruding toward the other opposing connector fixing portion 1425 at a front end in a direction protruding from the flat surface 1420. A distance from this portion to the flat surface 1420 is equal to or slightly longer than a length of the connector distal end X2a in the D1 direction. Accordingly, the connector distal end X2a fixed between the pair of connector fixing portions 1425 is prevented from moving in the direction D1 and the direction D2.

Here, locking of the first mounting portion 142A to the outer peripheral edge 22 will be described with reference to FIG. 13. When the first mounting portion 142A is locked to the outer peripheral edge 22, the pair of locking portions 1421 and the locking portion 1422 are elastically deformed in directions away from each other, which are directions including a direction parallel to the direction D1, and the outer peripheral edge 22 including the rib 221 and the concave portion 222 is guided to a position below the pair of locking portions 1421 and above the locking portion 1422. In this state, when a force is applied to move the first mounting portion 142A in a direction parallel to the flat surface 21 and away from the base center P, the rib 221 and each locking portion 1421 come into contact with each other, and/or the rib 1422a and the concave portion 222 come into contact with each other, so as to prevent the first mounting portion 142A from moving in this direction. That is, in the above-described state, the first mounting portion 142A is locked to the outer peripheral edge 22. When a force is further applied in this state, the pair of locking portions 1421 and the locking portion 1422 are elastically deformed again, so that the locking is released.

Note that when a distance between each locking portion 1421 and the locking portion 1422 in the direction D1 is smaller than the thickness of the base 2 in a state where the outer peripheral edge 22 is not locked by the pair of locking portions 1421 and the locking portion 1422, the base 2 is sandwiched and fixed by the restoring forces of each of the locking portions 1421 and the locking portion 1422. Therefore, the first mounting portion 142A can be more strongly locked to the outer peripheral edge 22, and in this state, the position of the first mounting portion 142A is less likely to be displaced.

### Third Embodiment

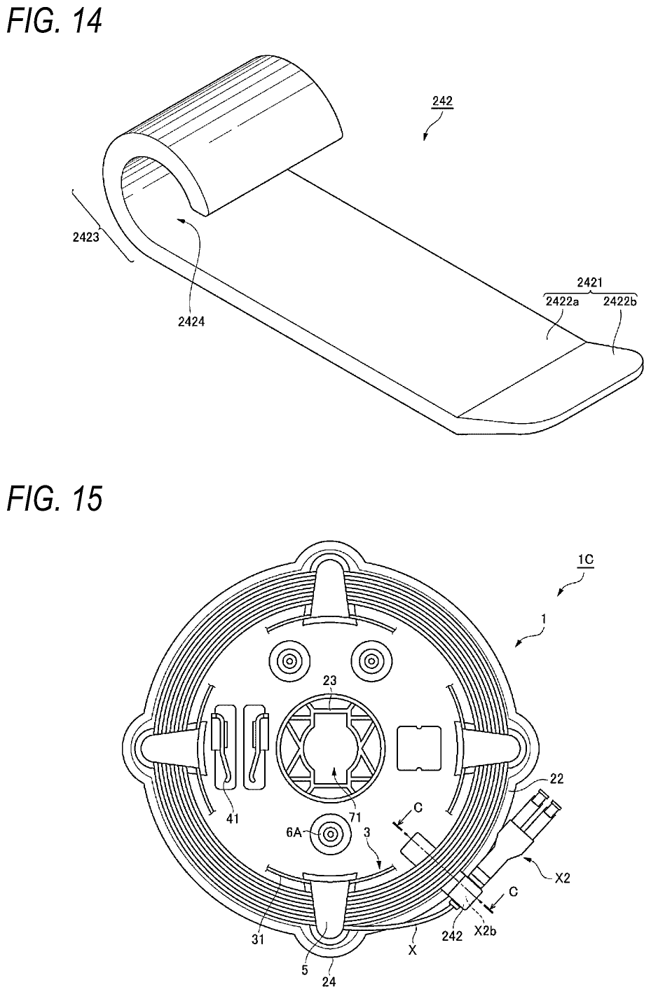

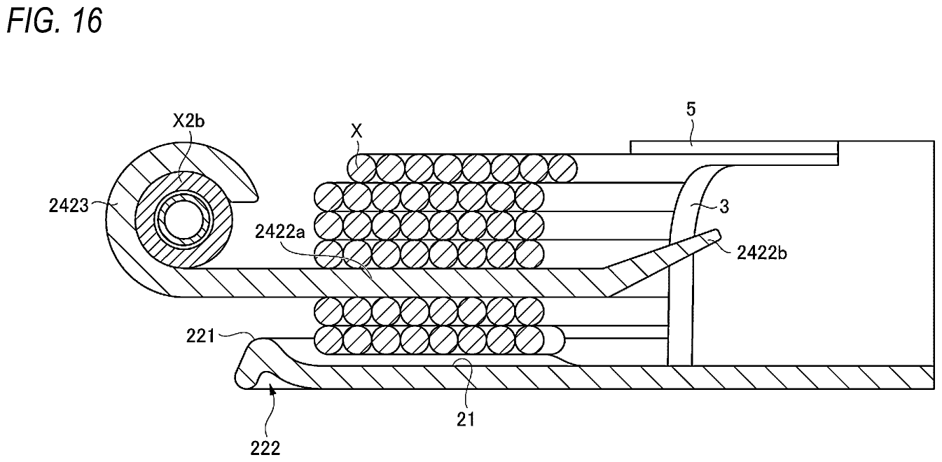

A third embodiment will be described with reference to FIGS. 14 to 16. FIG. 14 is a perspective view showing a first mounting portion 242 of a package for an optical fiber according to the third embodiment of the present disclosure. FIG. 15 is a perspective view of a package product 1C for an optical fiber according to the third embodiment of the present disclosure. FIG. 16 is a cross-sectional view cleaved along a line C-C shown in FIG. 15.

Note that the package 1 according to the second embodiment may be the same as the package 1 according to the first embodiment except that a first mounting portion 242 is provided instead of the first mounting portion 42. In the first mounting portions 242, members having the same names as those of the first mounting portion 42 may have the same functions as those of the first mounting portion 42. Therefore, the description of the same portions as in the first embodiment will be appropriately omitted. In the third embodiment, the contents described in the first embodiment can be applied within a range in which no contradiction occurs.

As shown in FIG. 14, the first mounting portion 242 includes a locking portion 2421 and a connector fixing portion 2423. The first mounting portion 242 is made of an elastically deformable material.

The locking portion 2421 includes a plate-shaped portion 2422a and a detachment prevention portion 2422b. The plate-shaped portion 2422a is a plate-shaped member inserted between a part of the optical fiber X wound around the plurality of protrusions 3 and the other part of the optical fiber X or between the optical fiber X and the base 2. The detachment prevention portion 2422b is provided so as to extend from one end of the plate-shaped portion 2422a in a direction different from the direction in which the plate-shaped portion 2422a extends. The connector fixing portion 2423 has a C-shaped cross section and fixes the connector rear end X2b to a space connected to the opening. The slit of the connector fixing portion 2423 functions as an optical fiber passage portion 2424.

FIG. 15 shows the package product 1C for an optical fiber according to the third embodiment. In the package product 1C, the optical fiber X having a connector mounted to at least one end of the optical fiber X is housed in the package 1. Similarly to the first embodiment, the package product 1C houses the optical fiber X having one end to which the first connector X2 is mounted and the other end to which the second connector X1 is mounted, but the second connector X1 is omitted in the drawing. In the package product 1C, the first connector X2 is mounted to the first mounting portion 242. The first mounting portion 242 is engaged with the optical fiber X wound around the plurality of protrusions 3 in the vicinity of the outer peripheral edge 22.

As shown in FIG. 16, the connector rear end X2b of the first connector X2 is fixed inside the connector fixing portion 2423. In the present embodiment, since an inner diameter of the connector fixing portion 2423 is smaller than at least a part of a diameter of the connector rear end X2b, the connector fixing portion 2423 fixes the connector rear end X2b by a restoring force while being elastically deformed and expanded. In this state, movement of the connector rear end X2b in the direction D1 and the direction D2 is prevented. Note that by elastically deforming the connector fixing portion 2423, the connector rear end X2b can be mounted and removed.

As shown in FIG. 16, the plate-shaped portion 2422a is inserted between a part of the optical fiber X wound around the plurality of protrusions 3 and the other part of the optical fiber X. In this state, the plate-shaped portion 2422a is loosely locked to the optical fiber X by a weight of the optical fiber X positioned above and a frictional force with the optical fiber X in contact therewith. In this state, when a force that moves the first mounting portion 242 in a direction parallel to the flat surface 21 and away from the base center P is applied, it is possible to prevent the detachment prevention portion 2422b from being caught on the optical fiber X above the plate-shaped portion 2422a and to prevent the locking of the first mounting portion 242 from being released. Note that the first mounting portion 242 may be locked by being inserted between the optical fiber X wound around the plurality of protrusions 3 and the flat surface 21 of the base 2.

### Lead-out Method

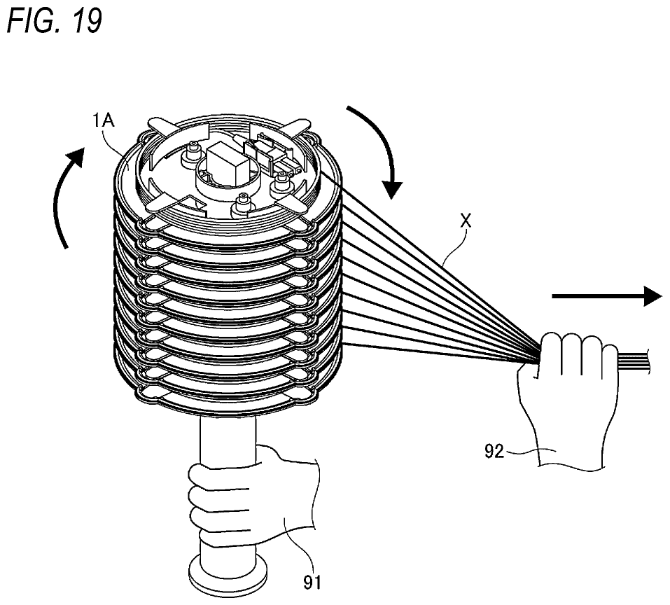

A method for leading out an optical fiber from a package product for an optical fiber will be described with reference to FIGS. 17 to 19. FIG. 17 is a perspective view of a multi-stacking fixture 8 used for leading out the optical fiber from the package product. FIG. 18 is a perspective view showing a state in which the package product 1A is attached to the multi-stacking fixture 8 shown in FIG. 17. FIG. 19 is a schematic view for explaining a method for leading out the optical fiber X from a plurality of the package products 1A using the multi-stacking fixture 8 in FIG. 17. Note that the lead-out method of the present disclosure can be applied to, for example, any of the package products 1A, 1B, and 1C without particular limitation as long as it is applied to a package around which the optical fiber X having a connector mounted to at least one end of the optical fiber X is wound and the connector is locked in the vicinity of an outer periphery of the package.

As shown in FIG. 17, the multi-stacking fixture 8 to which the package product 1A is attached includes a gripping portion 81, a shaft 82, a support portion 83, and a contact portion 84. The gripping portion 81 can be gripped by a worker and rotatably supports the shaft 82. In the present embodiment, the gripping portion 81 has a columnar shape, and a through hole 81H extending in an axial direction is formed inside the gripping portion 81. The shaft 82 has a rod shape, and a part of the shaft 82 is inserted into the through hole 81H of the gripping portion 81. In the present embodiment, a part of the shaft 82 inserted into the through hole 81H has a columnar shape. That is, the shaft 82 is coupled to the gripping portion 81 so as to be rotatable around the axial direction. Note that the shape of the gripping portion 81 is not limited to a columnar shape or a quadrangular column shape.

The shaft 82 includes an insertion portion 821 to which the package product 1A is attached. The insertion portion 821 is formed to be fitted into the insertion hole 71 of the package product 1A. In the present embodiment, the insertion portion 821 has a quadrangular column shape extending in the axial direction. The package product 1A is attached to the shaft 82 by inserting the insertion portion 821 into the insertion hole 71 of the package product 1A. Note that the shape of the insertion portion 821 of the shaft 82 is not limited to a column or a quadrangular column.

The support portion 83 supports the package product 1A attached to the shaft 82. Specifically, the support portion 83 is provided on the shaft 82, and has a placement surface 831 that allows placement of the package product 1A. The package product 1A guided to the insertion portion 821 via the guide wall 23 around the insertion hole 71 is placed on the placement surface 831 (see FIG. 18). A surface 832 of the support portion 83 opposite to the placement surface 831 functions as a contact surface that comes into contact with the gripping portion 81 when the shaft 82 is displaced in a rotational axis direction with respect to the gripping portion 81. In the present embodiment, the support portion 83 has a disc shape extending in a radial direction around the shaft 82, and the support portion 83 is formed to be larger than the gripping portion 81 when the multi-stacking fixture 8 is viewed in an axial direction of the shaft 82. Note that the shape of the support portion 83 is not limited to a disc.

The contact portion 84 is provided in an end 82E of the shaft 82. The contact portion 84 has a contact surface 841 that comes into contact with the gripping portion 81 when the shaft 82 is displaced in the rotational axis direction with respect to the gripping portion 81. In the present embodiment, the contact portion 84 has a disc shape, and the contact surface 841 is formed to be larger than the gripping portion 81 when the multi-stacking fixture 8 is viewed in the axial direction of the shaft 82. Note that the shape of the contact portion 84 is not limited to a disc.

When leading out the optical fiber X from the package product 1A, the worker attaches the package product 1A to the shaft 82 as shown in FIG. 18 ( S1). The first connector X2 locked in the vicinity of the outer periphery of the package product 1A is removed from the first mounting portion 42 ( S2). Then, the worker grips the gripping portion 81 with one hand, and pulls the first connector X2 or the optical fiber X coupled to the first connector X2 removed with the other hand ( S3). In this case, since the shaft 82 rotates with respect to the gripping portion 81, the insertion portion 821 and the package product 1A inserted into the insertion portion 821 rotate around a rotation axis of the shaft 82. In this way, when the first connector X2 or a part of the optical fiber X removed from the package product 1A is pulled, the package product 1A rotates together with the shaft 82 of the multi-stacking fixture 8, and thus the optical fiber X can be easily led out from the package product 1A. When the shaft 82 is displaced in the rotational axis direction with respect to the gripping portion 81, the shaft 82 can be prevented from coming off from the gripping portion 81 by the contact portion 84 coming into contact with the gripping portion 81. Note that either S1 or S2 may be executed first. From the viewpoint of workability, S1 is preferably executed first.

In FIG. 18, one package product 1A is attached to the multi-stacking fixture 8, but as shown in FIG. 19, a plurality of the package products 1A may be attached to the multi-stacking fixture 8 and stacked, and a plurality of the optical fibers X may be collectively led out from the plurality of package products 1A. Specifically, the plurality of package products 1A are attached to the shaft 82 ( S11). The first connectors X2 locked in the vicinity of the outer periphery of the package products 1A are removed from the first mounting portions 42 ( S12). Then, the worker grips the gripping portion 81 with one hand 91, and collectively pulls the first connectors X2 or a part of the optical fibers X connected to the first connectors X2, which is removed from the plurality of package products 1A attached to the shaft 82, with the other hand 92 (step S13). In this way, the optical fibers X can be collectively led out from the plurality of package products 1A by one time of pulling operation. Note that either step S11 or step S12 may be executed first. From the viewpoint of workability, step S11 is preferably executed first.

Note that since the insertion hole 71 is a non-circular hole, it is possible to prevent the plurality of stacked package products 1A from rotating individually with respect to the insertion portion 821. That is, the worker can collectively rotate the plurality of package products 1A together with the insertion portion 821 in the same cycle.

The first connector X2 removed from each of the plurality of package products 1A is connected to, for example, an external device. The first connector X2 may be connected to an external device after the optical fiber X is removed from the package product 1A, or may be connected to an external device before the optical fiber X is removed from the package product 1A.

Although the present disclosure has been described in detail with reference to the specific embodiments, it is apparent to those skilled in the art that various changes and modifications can be made without departing from the spirit and scope of the present disclosure. In addition, the number, positions, shapes, and the like of the constituent members described above are not limited to those in the above embodiments, and can be changed to the numbers, positions, shapes, and the like suitable for carrying out the present disclosure. In each of the embodiments, elements included in other embodiments can be combined.

### REFERENCE SIGNS LIST

1: package
1A, 1B, 1C: package product
2: base
21: flat surface
22: outer peripheral edge
221: rib
222: concave portion
23: guide wall
24: extending portion
3: protrusion
31: outer peripheral surface
4: mounting portion
41: second mounting portion
411: gripping portion
411A: convex portion
411B: connection portion
411C: non-connection portion
411E1: front end
411E2: first end
411E3: second end
411S: surface
42, 142A, 142B, 242: first mounting portion
421, 1421, 1422, 2421: locking portion
422, 1422a: rib
423, 1423, 1425, and 2423: connector fixing portion
424, 1424, 2424: optical fiber passage portion
425a, 425b: clamping portion
1420: flat surface
1426: guide portion
2422a: plate-shaped portion
2422b: detachment prevention portion
5: falling-off prevention portion
6A, 6B: connection portion
7: central protrusion
71: insertion hole
8: multi-stacking fixture
81: gripping portion
81H: through hole
82: shaft
82E: end
821: insertion portion
83: support portion
831: placement surface
832: surface
84: contact portion
841: contact surface
91, 92: hand (of worker)
X: optical fiber
X1: second connector
X2: first connector
X2a: connector distal end
X2b: connector rear end
C: cap
P: base center
D1, D2: direction
D10, D20: interval
L1, L2: line
W1, W2: width

1. A package for an optical fiber configured to house an optical fiber having a connector mounted to at least one end of the optical fiber, the package comprising:
a base having a flat surface;
a plurality of protrusions protruding from the flat surface of the base and arranged along an outer periphery of the base;
a first mounting portion to which the connector of the optical fiber is mounted; and
a plurality of falling-off prevention portions configured to regulate a position of the optical fiber, wherein
the plurality of protrusions are configured such that the optical fiber is wound along a part of an outer periphery of each of the plurality of protrusions, and
the first mounting portion includes a locking portion provided such that the first mounting portion is locked to an outer peripheral edge of the base or the optical fiber.

2. The package for an optical fiber according to claim 1, wherein
the locking portion is provided such that the first mounting portion is locked to the outer peripheral edge of the base,
the first mounting portion includes a first connector fixing portion for fixing the connector, and
the first connector fixing portion has a C-shaped cross section and is configured to mount the connector in a space connected to an opening.

3. The package for an optical fiber according to claim 2, wherein the first mounting portion includes two or more locking portions, and
the first mounting portion further includes
the first connector fixing portion for fixing a rear end of the connector, and
a second connector fixing portion for fixing the other portion of the connector different from the rear end.

4. The package for an optical fiber according to claim 1, wherein
the locking portion locks the first mounting portion to the optical fiber by being inserted between a part of the optical fiber wound around the plurality of protrusions and the other part of the optical fiber, or between the optical fiber and the base.

5. The package for an optical fiber according to claim 1, further comprising:
the second mounting portion different from the first mounting portion, wherein
the second mounting portion is constituted by a pair of gripping portions positioned closer to a center of the base than the plurality of protrusions, the pair of gripping portions protruding from the flat surface of the base and being arranged to face each other in a first direction that intersects a direction in which the pair of gripping portions protrude from the flat surface of the base.

6. The package for an optical fiber according to claim 1, further comprising:
a rib protruding from the flat surface of the base and provided along the outer peripheral edge of the base.

7. The package for an optical fiber according to claim 1, wherein
a portion corresponding to each of the plurality of protrusions on the outer periphery of the base extends toward an outer side than the other portion on the outer periphery of the base.

8. The package for an optical fiber according to claim 1, wherein
the first mounting portion is integrally molded with the base, and is easily separable.

9. A package product, comprising:
an optical fiber having a connector mounted to at least one end of the optical fiber; and
the package for an optical fiber according to claim 1, wherein
the optical fiber is housed in the package for an optical fiber,
the connector is mounted to the first mounting portion, and
the first mounting portion is locked to the outer peripheral edge of the base or the optical fiber wound around the plurality of protrusions.

10. An optical fiber lead-out method for leading out an optical fiber having a connector mounted to at least one end of the optical fiber from a package product around which the optical fiber is wound and in which the connector is locked in a vicinity of an outer periphery of a package, the method comprising:
a step of removing the connector of the optical fiber from each of a plurality of the package products;
a step of stacking the plurality of package products and attaching the stacked package products to a rotatable fixture; and
a step of collectively pulling the connectors respectively removed from the plurality of package products attached to the fixture or a part of the optical fibers connected to the connectors.

11. An optical fiber lead-out method for leading out an optical fiber using a fixture from a package product, the package product being a package product in which an optical fiber having a connector mounted to at least one end of the optical fiber is wound around the package for an optical fiber according to claim 1, and in the package product, the connector being locked to the outer peripheral edge of the base or the optical fiber wound around the plurality of protrusions, wherein
the fixture includes
a shaft to which the package is attached,
a support portion provided on the shaft and having a placement surface that allows placement of the package,
a gripped portion configured to rotatably support the shaft, and
a contact portion provided at an end of the shaft and having a contact surface that comes into contact with the gripped portion when the shaft part is displaced in a rotational axis direction with respect to the gripped portion, and
the method comprises:
a step of removing the connector of the optical fiber from each of a plurality of the package products;
a step of stacking the plurality of package products and attaching the stacked package products to the fixture; and
a step of collectively pulling the connectors respectively removed from the plurality of package products attached to the fixture or a part of the optical fibers connected to the connectors.
